(19) United States
(12) Patent Application Publication
(10) Pub. No.: US 2025/0274548 A1
(43) Pub. Date: Aug. 28, 2025

(54) MANAGEMENT APPARATUS, SYSTEM, AND INFORMATION PROCESSING METHOD

(71) Applicant: Oki Electric Industry Co., Ltd., Tokyo (JP)

(72) Inventors: Atsushi KOSUGI, Tokyo (JP); Satoshi MINONO, Tokyo (JP); Yasuhisa KITAI, Tokyo (JP)

(73) Assignee: Oki Electric Industry Co., Ltd., Tokyo (JP)

(21) Appl. No.: 18/984,907

(22) Filed: Dec. 17, 2024

(30) Foreign Application Priority Data
Feb. 26, 2024 (JP) 2024-026462

(51) Int. Cl. H04M 3/523; H04M 3/51

(52) U.S. Cl. CPC H04M 3/5235; H04M 3/5133; H04M 3/5183; H04M 2201/42

(57) ABSTRACT

A management apparatus including a control unit configured to determine actuation of an action plan on a basis of sensor data acquired by a terminal apparatus and control an operator terminal to cause the operator terminal to present the action plan determined to be actuated, wherein in a case where actuation of a plurality of the action plans is determined, the control unit controls the operator terminal to cause the operator terminal to present the action plan of highest priority.

### CROSS REFERENCE TO RELATED APPLICATION(S)

This application is based upon and claims benefit of priority from Japanese Patent Application No. 2024-026462, filed on Feb. 26, 2024, the entire contents of which are incorporated herein by reference.

### BACKGROUND

The present invention relates to a management apparatus, a system, and an information processing method.

In recent years, technology of performing various jobs with robots has been promising as means for solving labor shortage accompanying depopulating society. An example includes a robot system in which an operator makes various decisions on the basis of information collected by a robot and remotely operates the robot. When it is determined from data collected by a robot that an alert is issued in the robot system, an operator checks the content of the alert and causes the robot to execute the next operation. As technology for assisting an operator to handle an alert, for example, JP 6996129B discloses technology that offers assistance to allow an operator to execute an appropriate action upon an incoming call in a call center.

### SUMMARY

The technology disclosed in JP 6996129B, however, assigns incoming calls to one operator one by one in order. That is, nothing is taken into consideration about the priorities of alerts. This may put off the handling of an alert to be immediately handled.

Accordingly, the present invention has been devised in view of the problem described above. An object of the present invention is to provide a mechanism that allows an alert to be handled in accordance with priority.

To solve the above described problem, according to an aspect of the present invention, there is provided a management apparatus comprising a control unit configured to determine actuation of an action plan on a basis of sensor data acquired by a terminal apparatus and control an operator terminal to cause the operator terminal to present the action plan determined to be actuated, wherein in a case where actuation of a plurality of the action plans is determined, the control unit controls the operator terminal to cause the operator terminal to present the action plan of highest priority.

In a case where actuation of the action plan that is higher in priority than the action plan that is being presented by the operator terminal is determined, the control unit may control the operator terminal to cause the operator terminal to switch the action plan to be presented to the action plan that is higher in priority.

In a case where processing of the action plan is completed, the control unit may control the operator terminal to cause the operator terminal to present the action plan of the highest priority among the other action plans whose processing has not yet been completed.

In a case where a switching instruction to switch the action plan to be presented is inputted to the operator terminal, the control unit may control the operator terminal to cause the operator terminal to switch the action plan to be presented in accordance with the switching instruction.

In a case where the action plan to be presented is switched in accordance with the switching instruction, the control unit may decrease priority of the action plan before switching and/or increase priority of the action plan after the switching.

The control unit may perform control to cause the operator terminal of an operator having a smaller number of calls to preferentially present the action plan.

To solve the above described problem, according to another aspect of the present invention, there is provided a system comprising: a terminal apparatus configured to acquire sensor data; an operator terminal configured to be operated by an operator; and a management apparatus configured to determine actuation of an action plan on a basis of the sensor data and control the operator terminal to cause the operator terminal to present the action plan determined to be actuated, wherein in a case where actuation of a plurality of the action plans is determined, the management apparatus controls the operator terminal to cause the operator terminal to present the action plan of highest priority.

In a case where the actuation of a plurality of the action plans is determined, the operator terminal may display a list of a plurality of the action plans in order of priority.

The terminal apparatus may be an autonomously movable robot.

To solve the above described problem, according to another aspect of the present invention, there is provided an information processing method that is executed by a computer, the information processing method comprising determining actuation of an action plan on a basis of sensor data acquired by a terminal apparatus and controlling an operator terminal to cause the operator terminal to present the action plan determined to be actuated, wherein in a case where actuation of a plurality of the action plans is determined, the controlling the operator terminal includes controlling the operator terminal to cause the operator terminal to present the action plan of highest priority.

As described above, according to the present invention, there is provided a mechanism that allows an alert to be handled in accordance with priority.

### BRIEF DESCRIPTION OF THE DRAWINGS

FIG. 1 is a block diagram illustrating an example of a configuration of a system 1 according an embodiment of the present invention.

FIG. 2 is a diagram illustrating an example of an off-limits place.

FIG. 3 is a diagram illustrating an example of a UI screen that is displayed on an operator terminal 20 according to the present embodiment.

FIG. 4 is a diagram illustrating an example of the UI screen that is displayed on the operator terminal 20 according to the present embodiment.

FIG. 5 is a flowchart illustrating an example of a flow of processing that is executed by the system 1 according to the present embodiment.

FIG. 6 is a flowchart illustrating an example of the flow of the processing that is executed by the system 1 according to the present embodiment.

FIG. 7 is a flowchart illustrating an example of a flow of processing that is executed by the system 1 according to a modification example.

FIG. 8 is a block diagram illustrating an example of a hardware configuration of an information processing apparatus according to the present embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Overview

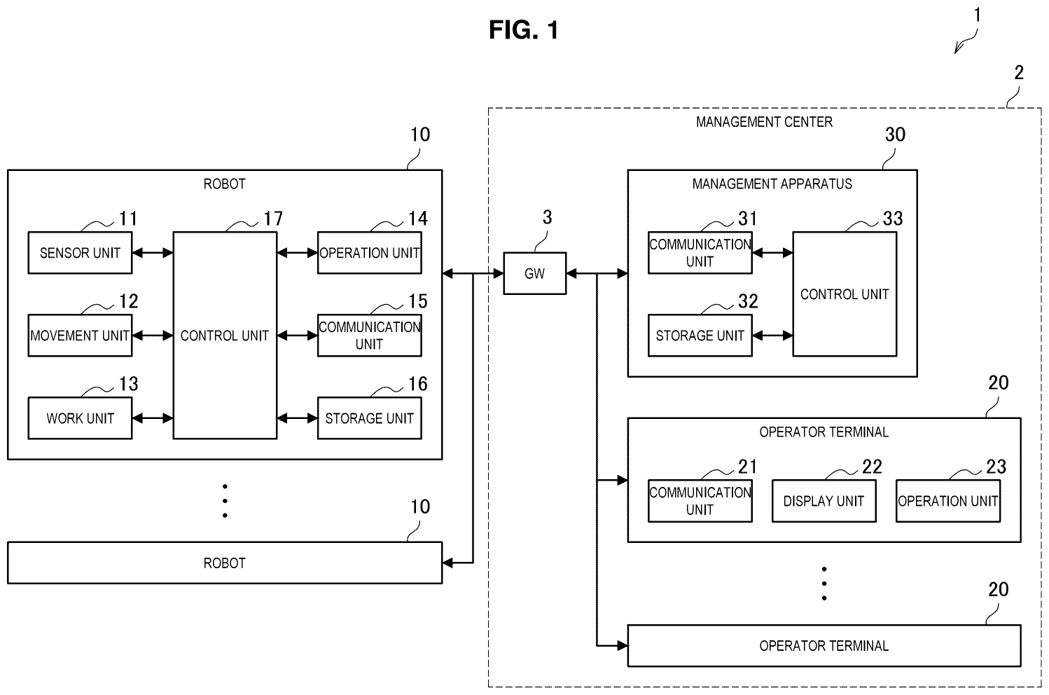

An overview of an embodiment of the present invention will be described below with reference to FIG. 1.

FIG. 1 is a block diagram illustrating an example of a configuration of a system 1 according to the embodiment of the present invention. As illustrated in FIG. 1, the system 1 may include a plurality of robots 10, a plurality of operator terminals 20, and a management apparatus 30.

It will be assumed below that the system 1 performs the job of monitoring a facility. The facility includes a company building, a commercial facility, a warehouse, or the like.

Each of the robots 10 is a terminal apparatus that executes a predetermined operation or task (also referred to collectively as an action below). Examples of the action include moving, stopping, standing by, reproducing sound, and the like. The robot 10 may be autonomously movable. For example, the robot 10 is disposed in each floor of a facility to be monitored, acquires various kinds of data such as a camera image while autonomously patrolling the floor, and transmits the various kinds of data to the management apparatus 30.

Here, the robot 10 may be construed as an “android”, “what performs an operation or a task similar to that of a human”, an “apparatus that performs an operation or a task through a computer operation on the basis of an instruction”, or an “apparatus that performs an autonomous operation or task through a computer operation”. Alternatively, the robot 10 may be construed as a “machine that has a manipulation function or a movement function under automatic control, is capable of executing various tasks by using a program, and is used for industry” (JIS B 0134-1998). Alternatively, the robot 10 may be construed as a “robot that serves a human” (JIS B 0187:2005). Alternatively, the robot 10 may be construed as an “intelligent mechanical system having the three underlying technologies of a sensor, an intelligence/control system, and a drive system” (Robot Seisaku Kenkyukai (Study Group on Robot Policies), Ministry of Economy, Trade and Industry).

The operator terminal 20 and the management apparatus 30 are disposed in a management center 2 and connected to the robot 10 through a gate way (GW) 3 in a communicable manner. The management center 2 may be disposed, for example, in a remote place different from the place of a facility to be monitored. The communication path between the robot 10 and the operator terminal 20 or the management apparatus 30 may comply with any wired/wireless communication standard such as the Internet or a local network.

The management apparatus 30 is an information processing apparatus that controls the handling of an alert. If described in detail, the management apparatus 30 determines on the basis of data collected from the robot 10 that an alert is issued, and controls the execution of an action corresponding to the issued alert.

When an alert is issued, an action plan corresponding to the issued alert is actuated and an action included in the action plan is selectively executed in accordance with an instruction by an operator. The action plan is a set of one or more actions that may be executed in response to an alert.

Here, an alert may be understood as a problem to be solved. In addition, an action plan may be understood as a set of one or more actions that may be executed to solve the problem for the alert. Executing an action included in the action plan to solve the problem will also be referred to as handling the alert or processing the action plan. Issuing an alert is synonymous with actuating an action plan.

The operator terminal 20 is a remote console for remotely operating the robot 10. The operator terminal 20 receives an operation by an operator for processing the actuated action plan. If described in detail, the operator terminal 20 displays a UI screen that presents the content of the issued alert, that is, the content of the actuated action plan and receives an operation of selecting an action to be executed from the plurality of action options included in the action plan. After that, the action selected by the operator is executed.

Furthermore, an action included in the action plan is typically executed by the robot 10. In addition, an action included in the action plan may be executed by an apparatus such as the operator terminal 20 or the management apparatus 30 other than the robot 10.

The operator terminal 20 may also be operated by a manager who manages the job of the operator in addition to the operator. The manager operates the operator terminal 20 as necessary instead of the operator.

In the system 1 described above, various alerts may be issued at the same time. For example, while the robot 10 is patrolling, an alert indicating that the battery of the robot 10 is low and an alert indicating that a suspicious person is detected may be issued at the same time.

In this case, it is desirable to handle the plurality of alerts issued at the same time with an interrupt in accordance with priority. For example, in a case where the alert indicating that a suspicious person is detected is issued immediately after the alert indicating that the battery is low is issued, it is desirable that the handling of the alert indicating that the battery is low be interrupted and the alert indicating that a suspicious person is detected be preferentially handled.

It has been, however, difficult in the past to handle alerts in accordance with priority. For example, in a case where a plurality of alerts is issued at the same time, it depends on an operator to determine which alert is preferentially handled. This causes various disadvantages, for example, like an operator who is not used to handling an alert makes a wrong determination about priority and puts off the handling of an alert to be preferentially handled and it takes a longer time for solution.

Additionally, it is conceivable that a plurality of alerts is divided to and handled by a plurality of operators to solve such a problem. In this case, a plurality of operators may, however, instruct the one robot 10 to execute different actions and cause a disadvantage such as inconsistency.

Accordingly, the system 1 according to the present embodiment switches an action plan to be presented to an operator in accordance with the priority of the actuated action plan to achieve the handling of an alert that complies with priority. As a result, it is possible to have operators handle alerts in a uniform manner with higher quality.

### 2. Configuration Example

FIG. 1 will be referred to again below and a configuration example of the system 1 will be described in detail.

### <2.1. Configuration Example of Robot 10>

As illustrated in FIG. 1, the robot 10 includes a sensor unit 11, a movement unit 12, a work unit 13, an operation unit 14, a communication unit 15, a storage unit 16, and a control unit 17.

The sensor unit 11 includes various sensors and acquires and outputs various kinds of information. The sensor unit 11 may include, for example, a camera, a microphone, a thermometer, a barometer, and the like and acquire various kinds of information about the inside of a facility to be monitored. The sensor unit 11 may include a positional information sensor, an acceleration sensor, an angular velocity sensor, a battery sensor, and the like and acquire information indicating the state of the robot 10. Moreover, the positional information sensor may be a global navigation satellite system (GNSS) receiver and may acquire positional information about the robot 10 by estimating its own position in an environmental map on the basis of a camera image or the like.

The movement unit 12 is a device that moves the robot 10. The movement unit 12 includes, for example, a motor, a wheel, and the like and moves the robot 10 by driving the wheel by the motor.

The work unit 13 is a device that exerts various effects on the surroundings of the robot 10. As an example, the work unit 13 may include a sound output device such as a speaker and reproduce sound. As another example, the work unit 13 may include a display device such as a display and display an image. As another example, the work unit 13 may include a robot arm and pick up trash on the floor or depress a switch on the wall surface.

The operation unit 14 is a device that receives a user operation. As an example, the operation unit 14 may include a touch panel. The operation unit 14 receives, for example, an operation for the maintenance of the robot 10.

The communication unit 15 is a device that communicates with another apparatus. For example, the communication unit 15 transmits and receives information to and from the other robot 10, the operator terminal 20, or the management apparatus 30.

The storage unit 16 stores various kinds of information for an operation of the robot 10. For example, the storage unit 16 stores map information about a facility to be monitored or temporarily stores sensor data acquired by the sensor unit 11.

The control unit 17 controls an overall operation of the robot 10. The control unit 17 may include artificial intelligence (AI). For example, the control unit 17 determines the surrounding situation around the robot 10 on the basis of sensor data acquired by the sensor unit 11. The control unit 17 then controls operations of the various structural elements of the robot 10 described above in accordance with the determined surrounding situation. Specifically, the control unit 17 controls the movement unit 12 to cause the movement unit 12 to autonomously move in accordance with the determined surrounding situation or controls the work unit 13 to cause the work unit 13 to execute an operation that the work unit 13 is instructed to do by the management apparatus 30.

### <2.2. Configuration Example of Operator Terminal 20>

As illustrated in FIG. 1, the operator terminal 20 includes a communication unit 21, a display unit 22, and an operation unit 23.

The communication unit 21 is a device that communicates with another apparatus. For example, the communication unit 21 transmits and receives information to and from the robot 10 or the management apparatus 30. Additionally, the communication unit 21 may perform communication for contacting various staff members such as an equipment manager or a security guard of a facility to be monitored. Moreover, the equipment manager is a staff member who manages the equipment of a facility to be monitored. The security guard is a staff member who guards a facility to be monitored.

The display unit 22 outputs information for an operator. The display unit 22 displays, for example, a UI screen for processing an action plan.

The operation unit 23 receives an operation from an operator. The operation unit 23 receives, for example, an input to a UI screen displayed on the display unit 22.

### <2.3. Configuration Example of Management Apparatus 30>

As illustrated in FIG. 1, the management apparatus 30 includes a communication unit 31, a storage unit 32, and a control unit 33.

### (1) Communication Unit 31

The communication unit 31 is a device that communicates with another apparatus. For example, the communication unit 31 transmits and receives information to and from the robot 10 or the operator terminal 20.

### (2) Storage Unit 32

The storage unit 32 stores various kinds of information for an operation of the management apparatus 30. For example, the storage unit 32 stores a database in which various kinds of information regarding the job of monitoring a facility are stored.

Examples of databases stored in the storage unit 32 will be described below.

### (Robot Table)

A robot table is a database in which various kinds of information regarding the robot 10 are stored. Table 1 below is an example of the robot table.

TABLE 1
Example of Robot Table

| robot | current | current | current action | |
|---|---|---|---|---|
| ID | position | floor | plan ID | current action |
| R-101 | (0, 5) | 5F | A-202 | wait for an option to |
| | | | | be selected for a |
| | | | | burned-out |
| | | | | fluorescent light |
| R-102 | (−6, −5) | 3F | — | — |

The robot ID shown in Table 1 is identification information for uniquely identifying the robot 10.

The current position is information indicating the current position of the robot 10 in the horizontal direction and is expressed, for example, by XY coordinates.

The current floor is information indicating the current position of the robot 10 in the height direction and is expressed, for example, by a floor of a facility to be monitored.

The current action plan ID is identification information about an action plan in which the robot 10 is currently involved.

The current action is the content of an action that the robot 10 is currently executing.

It should be noted that, in a case where an action included in an action plan is executed by the robot 10, the storage unit 32 writes the action plan ID of the action plan in the current action plan ID. The storage unit 32 then writes the name of the action to be executed in the current action. The storage unit 32 may delete the current action after the action is completed. In addition, the storage unit 32 may delete the current action plan ID in a case where the processing of the action plan is completed.

### (Off-Limits Place Table)

An off-limits place table is a database in which a place that the robot 10 is prohibited from entering is stored. Table 2 below is an example of the off-limits place table.

TABLE 2
Example of Off-limits Place Table

| area | floor |
|---|---|
| (−10, −10) to (10, 10) | 5F |
| (−20, −15) to (20, 15) | 3F |

The area shown in Table 2 is information indicating the area of an off-limits place in the horizontal direction and is expressed, for example, by the combination of the two XY coordinates indicating two vertices included in opposite angles of a rectangle.

The floor is information indicating the position of an off-limits place in the height direction and is expressed, for example, by a floor of a facility to be monitored.

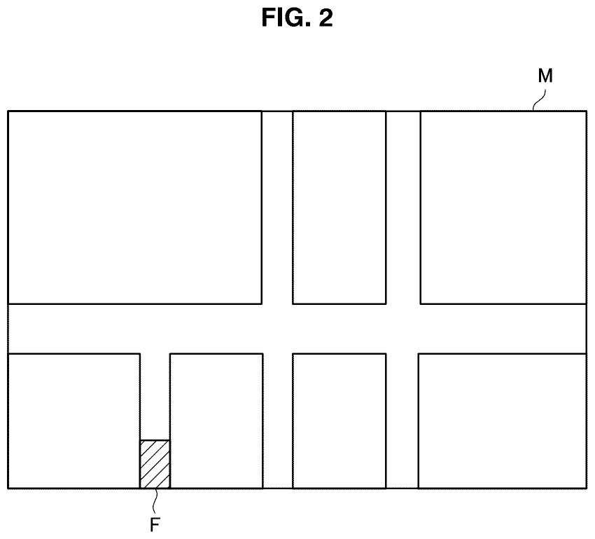

FIG. 2 is a diagram illustrating an example of an off-limits place. As illustrated in FIG. 2, an off-limits place F may be set in map information M for each floor. The coordinates that define the off-limits place F may be then stored in the off-limits place table.

### (Detection Table)

A detection table is a database in which detection data is stored. Table 3 is an example of the detection table.

TABLE 3
An Example of a Detection Table

| detection time | detection name | detection data |
|---|---|---|
| 2023 Dec. 14 12:35:30 | burned-out | . . . |
| | fluorescent | |
| | light | |
| 2023 Dec. 14 12:36:29 | intrusion of | . . . |
| | person on off- | |
| | limits place | |

The detection time shown in Table 3 is time at which detection data is detected.

The detection name is a name corresponding to detection data.

The detection data is information indicating the situation of the monitoring job. The detection data includes sensor data such as a captured image, sound, and temperature and air temperature, and the acceleration, the angular velocity, the positional information, and the remaining battery of the robot 10 acquired by the sensor unit 11 of the robot 10.

As an example, detection data of a detection name “burned-out fluorescent light” includes an image obtained by imaging a fluorescent light being burned out. As another example, detection data of a detection name “intrusion of person on off-limits place” includes an image obtained by imaging a person intruding on an off-limits place.

In addition, the detection data may include a result of processing based on the sensor data. The processing based on the sensor data may be executed by the AI mounted on the robot 10 or executed by the control unit 33. Examples of the processing based on the sensor data include image recognition, position estimation, and situation determination.

As an example, it may be determined by the control unit 33 whether or not a person intrudes on an off-limits place. If described in detail, the control unit 33 may estimate positional information about a person included in an image captured by the robot 10 on the basis of the captured image, the angle of field, and the positional information about the robot 10. The control unit 33 may then determine whether or not the person intrudes on the off-limits place by determining whether or not the estimated positional information is included in the off-limits places stored in the off-limits place table shown in Table 2. In addition, the detection data of “intrusion of person on off-limits place” may include an estimation value of the number of people who intrude on the off-limits place. The same applies to “burned-out fluorescent light”. The robot 10 or the control unit 33 may estimate whether or not a fluorescent light is burned out. The detection data may include an estimation value of the number of burned-out fluorescent lights.

### (Action Plan Table)

An action plan table is a database in which information regarding an action plan is stored. Table 4 is an example of the action plan table.

TABLE 4
An Example of an Action Plan Table

| action | actuation | | initial | notification | |
|---|---|---|---|---|---|
| plan ID | condition | priority | action | message | option |
| A-101 | battery | 5 | notify | low battery | going back to |
| | <10% | | remote | | charging place |
| | | | console | | continue |
| | | | | | processing |
| A-102 | the number | 5 | notify | malfunctioning | going back to |
| | of times NW | | remote | NW | charging place |
| | of robot is | | console | | continue |
| | disconnected | | | | processing |
| | >5 | | | | |
| A-201 | the number | 5 | notify | crowded | none |
| | of people | | remote | | |
| | ≥10 | | console | | |
| A-202 | burned-out | 10 | notify | burned-out | contact |
| | fluorescent | | remote | fluorescent | equipment |
| | light = 1 | | console | light | manager |
| A-203 | lost items | 10 | notify | possibility of | call for |
| | ≥10 | | remote | lost item | security guard |
| | | | console | | doing nothing |
| A-204 | suspicious | 50 | notify | possibility of | none |
| | person = 1 | | remote | suspicious | |
| | | | console | person | |
| A-205 | suspicious | 100 | notify | possibility of | reproduce |
| | person = 1 | | remote | suspicious | sound |
| | and | | console | person (high | call for |
| | the number | | after | priority) | security guard |
| | of people ≥5 | | stopping | | doing nothing |
| | | | robot | | |
| A-206 | lying | 200 | notify | lying person | reproduce |
| | person = 1 | | remote | found | sound |
| | | | console | | call for |
| | | | after | | security guard |
| | | | stopping | | erroneous |
| | | | robot | | report |
| A-207 | person | 300 | notify | intrusion of | reproduce |
| | intruding on | | remote | person on off- | sound |
| | off-limits | | console | limits place | call for |
| | place = 1 | | after | | security guard |
| | | | stopping | | erroneous |
| | | | robot | | report |

The action plan ID shown in Table 4 is identification information that uniquely identifies an action plan.

The actuation condition is information indicating a condition for actuating an action plan and includes, for example, detection data that causes an action plan to be actuated in the case of detection.

The priority is information indicating the priority of an action plan. An action plan of higher priority is processed more preferentially.

The initial action is an action that is first executed automatically when an action plan is actuated.

The notification message is the content of a message that is displayed on the operator terminal 20.

The option is an action option that is to be executed next. The option is presented to an operator by the operator terminal 20.

### (Operator Table)

An operator table is a database in which various kinds of information regarding an operator are stored. Table 5 is an example of the operator table.

TABLE 5
An Example of an Operator Table

| operator ID | action plan ID | the number of calls |
|---|---|---|
| O-101 | A-101 | 1 |
| O-101 | A-102 | 3 |
| O-102 | A-102 | 1 |

The operator ID shown in Table 5 is identification information for uniquely identifying an operator.

The action plan ID is identification information about an action plan.

The number of calls is the number of times the operator corresponding to an operator ID was called to process the action plan corresponding to an action plan ID in the past. The number of calls corresponds to the number of times the action plan was processed in the past.

### (Others)

The storage unit 32 may store an operation log indicating a processing history of an action plan. The operation log includes, for example, an actuated action plan, actuation time, an executed action, an execution result, and the like.

### (3) Control Unit 33

The control unit 33 controls an overall operation in the system 1. For example, the control unit 33 controls an operation of the robot 10 and an operation of the operator terminal 20.

The control unit 33 has a function of controlling a connection between the robot 10 and the management apparatus 30. If described in detail, the control unit 33 controls the communication unit 31 to cause the communication unit 31 to transmit an operation instruction to the robot 10 and collect data from the robot 10. Additionally, various technologies such as message queue telemetry transport (MQTT) and web real-time communication (WebRTC) may be used for connection control over the robot 10.

The control unit 33 has a function of controlling the monitoring job with the robot 10. If described in detail, the control unit 33 performs display control over the operator terminal 20 and updates priority, which will be described below.

### (Display Control Over Operator Terminal 20)

The control unit 33 determines the actuation of an action plan on the basis of detection data collected from the robot 10. For example, the control unit 33 stores detection data collected from the robot 10 in the detection table and determines the actuation of an action plan whose actuation condition is satisfied by the detection data stored in the detection table.

The control unit 33 then controls the operator terminal 20 to cause the operator terminal 20 to present the action plan that is determined to be actuated. In particular, in a case where the actuation of a plurality of the action plans is determined, the control unit 33 controls the operator terminal 20 to cause the operator terminal 20 to present the action plan of the highest priority. The operator terminal 20 may present an action plan by displaying a UI screen that presents the action plan. According to this configuration, it is possible for an operator to preferentially process an action plan of high priority with reference to the UI screen displayed on the operator terminal 20.

In a case where the actuation of the action plan that is higher in priority than the action plan that is being presented by the operator terminal 20 is determined, the control unit 33 controls the operator terminal 20 to cause the operator terminal 20 to switch the action plan to be presented to the action plan that is higher in priority. According to this configuration, it is possible to process an action plan of high priority with an interrupt.

Meanwhile, in a case where the actuation of an action plan of lower priority than the priority of an action plan that the operator terminal 20 is presenting is determined, the control unit 33 controls the operator terminal 20 to cause the operator terminal 20 to retain the action plan that is being presented. According to this configuration, it is possible to prevent an interrupt by an action plan of low priority and continue processing an action plan of high priority.

Further, in a case where the processing of the action plan is completed, the control unit 33 controls the operator terminal 20 to cause the operator terminal 20 to present the action plan of the highest priority among the other action plans whose processing has not yet been completed. According to this configuration, it is possible to sequentially process action plans in the descending order of priority.

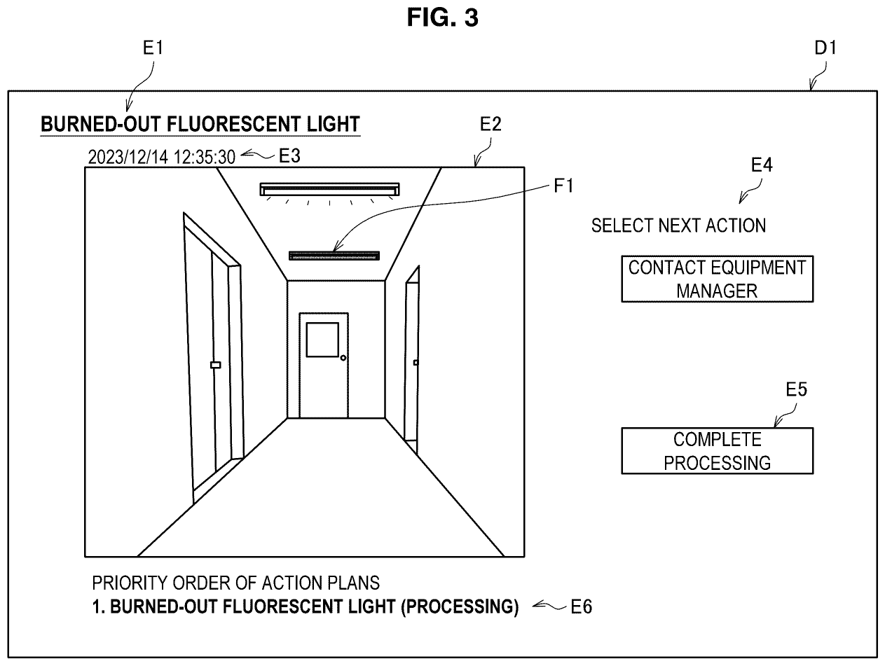

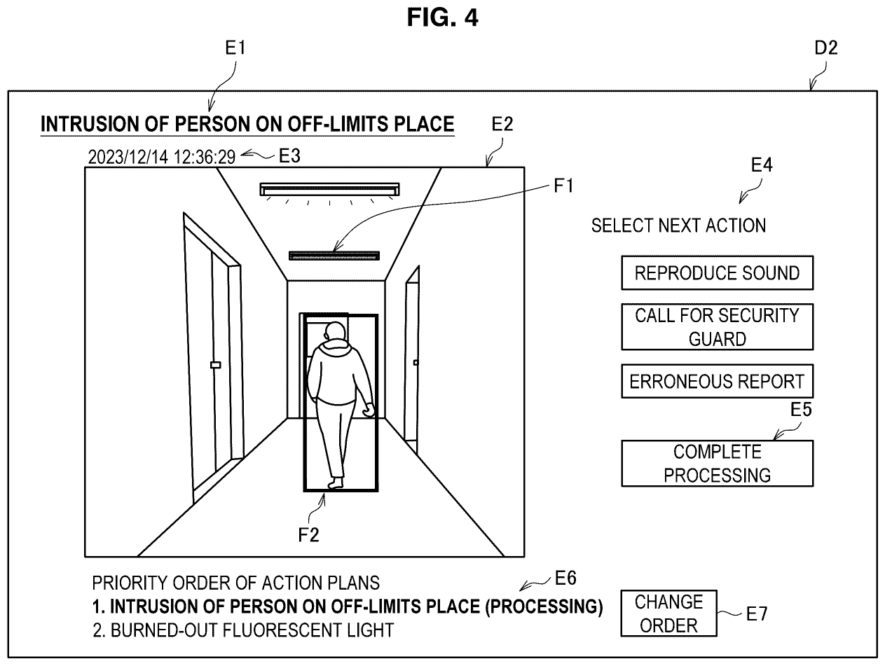

An example of a UI screen that is displayed on the operator terminal 20 in response to the actuation of an action plan and presents the action plan will be described below with reference to FIGS. 3 and 4.

FIG. 3 is a diagram illustrating an example of a UI screen that is displayed on the operator terminal 20 according to the present embodiment. A UI screen D1 illustrated in FIG. 3 is displayed by the operator terminal 20 when detection data of “burned-out fluorescent light” is acquired and the corresponding action plan is actuated.

If described in detail, as shown in Table 3, the control unit 33 first acquires an image obtained by imaging a fluorescent light being burned out as the detection data of “burned-out fluorescent light”. Subsequently, as shown in Table 4, the control unit 33 actuates the action plan of an action plan ID “A-202” whose actuation condition is the acquisition of the detection data of “burned-out fluorescent light”. Next, as shown in Table 4, the control unit 33 notifies the operator terminal 20 of a notification message “burned-out fluorescent light” in accordance with an initial action “notify remote console”. The operator terminal 20 then displays the UI screen D1 corresponding to the notification message “burned-out fluorescent light”. The UI screen D1 may be displayed in a pop-up manner.

As illustrated in FIG. 3, the UI screen D1 includes UI elements E1 to E6.

The UI element E1 displays the title of the UI screen D1. In the example illustrated in FIG. 3, the UI element E1 displays the notification message “burned-out fluorescent light” shown in Table 4.

The UI element E2 displays an image included in the detection data that satisfies the actuation condition of the action plan. The UI element E3 displays the detection time of the detection data that satisfies the actuation condition of the action plan. In the example illustrated in FIG. 3, the UI element E2 displays a captured image including a fluorescent light F1 on the back side that is off. The captured image is an image included in the detection data of “burned-out fluorescent light” shown in Table 3. In addition, the UI element E3 indicates the time at which the captured image is taken.

The UI element E4 displays one or more action options selectable by an operator as buttons. In the example illustrated in FIG. 3, the UI element E4 displays a “contact equipment manager” button that is an option in the action plan corresponding to “burned-out fluorescent light” shown in Table 4. When an operator selects the button, the control unit 33 controls the operator terminal 20 to cause the operator terminal 20 to contact the equipment manager to ask the equipment manager to replace the fluorescent light.

The UI element E5 is a button that receives an input of the processing completion of the action plan. When an operator selects the button, the control unit 33 completes the processing of the action plan. The control unit 33 then records an operation log from the actuation to the processing completion of the action plan and finishes the pop-up display of the UI screen D1.

The UI element E6 displays information indicating an action plan that is being processed while displaying a list of the plurality of actuated action plans in priority order (i.e., in the order of priority). In the example illustrated in FIG. 3, only the action plan corresponding to “burned-out fluorescent light” is actuated and the action plan is being processed. The UI element E6 thus displays “burned-out fluorescent light (processing)” at the first priority.

As shown in Table 3, the UI screen D1 described above is displayed on the operator terminal 20 in a pop-up manner immediately after the time “2023 Dec. 14 12:35:30”, at which the detection data of “burned-out fluorescent light” was detected.

It is assumed here that the detection data of “intrusion of person on off-limits place” is detected as shown in Table 3 at the time “2023 Dec. 14 12:36:29”, at which the UI screen D1 is being displayed, that is, the action plan of “burned-out fluorescent light” is being processed. An example of a UI screen displayed in this case is illustrated in FIG. 4.

FIG. 4 is a diagram illustrating an example of a UI screen that is displayed on the operator terminal 20 according to the present embodiment. A UI screen D2 illustrated in FIG. 4 is displayed by the operator terminal 20 when the detection data of “intrusion of person on off-limits place” is detected and the corresponding action plan is actuated while the UI screen D1 is being displayed, that is, the action plan of “burned-out fluorescent light” is being processed.

If described in detail, the control unit 33 first acquires an image obtained by imaging a person intruding on an off-limits place as the detection data of “intrusion of person on off-limits place” as shown in Table 3. Subsequently, as shown in Table 4, the control unit 33 actuates the action plan of an action plan ID “A-207” whose actuation condition is the acquisition of the detection data of “intrusion of person on off-limits place”. Next, as shown in Table 4, the control unit 33 notifies the operator terminal 20 of a notification message “intrusion of person on off-limits place” in accordance with the initial action “notify remote console”. The operator terminal 20 then displays the UI screen D2 corresponding to the notification message “intrusion of person on off-limits place”. The UI screen D2 may be displayed in a pop-up manner. As a result, the UI screen D1 is hidden.

Here, as shown in Table 4, the priority of the action plan according to the UI screen D1 is “10” and the priority of the action plan according to the UI screen D2 is “300”. The operator terminal 20 thus displays the UI screen D2 for the action plan of higher priority on the UI screen D1, that is, in the foreground.

As illustrated in FIG. 4, the UI screen D2 includes the UI elements E1 to E6 as with the UI screen D1 illustrated in FIG. 3. The contents of the UI elements E1 to E6 have been described above.

However, in the example illustrated in FIG. 4, the UI element E1 displays the notification message “intrusion of person on off-limits place” shown in Table 4.

In addition, the UI element E2 displays an image in which a frame F2 surrounding an intruding person is superimposed on a captured image including the person intruding on an off-limits place. The captured image is an image included in the detection data of “intrusion of person on off-limits place” shown in Table 3. In addition, the UI element E3 indicates the time at which the captured image is taken.

In addition, the UI element E4 displays a “reproduce sound” button, a “call for security guard” button, and an “erroneous report” button that are action options included in the action plan corresponding to “intrusion of person on off-limits place” shown in Table 4. When an operator selects the “reproduce sound” button, the control unit 33 controls the robot 10 to cause the robot 10 to reproduce sound that warns and requires the intruder to leave the off-limits place. When an operator selects the “call for security guard” button, the control unit 33 controls the operator terminal 20 to cause the operator terminal 20 to call for a security guard and make a voice call between the security guard and the operator. When an operator selects the “erroneous report” button, the control unit 33 recognizes that the intrusion of the person on the off-limits place is an erroneous report.

In addition, the UI element E5 is a button that receives an input of the processing completion of the action plan. When an operator selects the button, the control unit 33 completes the processing of the action plan corresponding to “intrusion of person on off-limits place” and finishes the pop-up display of the UI screen D2. That is, the control unit 33 displays again the UI screen D1 corresponding to “burned-out fluorescent light” that is hidden behind the UI screen D2.

Here, in the example illustrated in FIG. 4, the action plan corresponding to “burned-out fluorescent light” and the action plan corresponding to “intrusion of person on off-limits place” are actuated and the action plan corresponding to “intrusion of person on off-limits place” is being processed. Accordingly, the UI element E6 displays “intrusion of person on off-limits place (processing)” at the first priority and displays “burned-out fluorescent light” at the second priority.

Further, as illustrated in FIG. 4, the UI screen D2 includes a UI element E7. The UI element E7 is a button that receives a change in priority order. When an operator selects the button, the priority order of a plurality of actuated action plans is changed. For example, in the example illustrated in FIG. 4, when an operator selects the button, the action plan corresponding to “burned-out fluorescent light” is set at the first priority and the action plan corresponding to “intrusion of person on off-limits place” is set at the second priority. As a result, the UI screen D1 is displayed in the foreground in a pop-up manner and the UI screen D2 is hidden. It is possible for the operator to advance the processing of the action plan corresponding to “burned-out fluorescent light” in the UI screen D1. It should be noted that the UI element E6 of the UI screen D1 displayed in the foreground displays “burned-out fluorescent light (processing)” at the first priority and displays “intrusion of person on off-limits place” at the second priority.

### (Update of Priority)

As described above for the UI element E6 in FIG. 4, in a case where the actuation of a plurality of action plans is determined, the control unit 33 displays a list of the plurality of actuated action plans in order of priority. According to this configuration, it is possible for an operator to recognize the action plans that have not yet been processed and check whether or not the priority order is right.

As described above for the UI element E7 in FIG. 4, in a case where a switching instruction to switch the action plan to be presented is inputted to the operator terminal 20, the control unit 33 controls the operator terminal 20 to cause the operator terminal 20 to switch the action plan to be presented in accordance with the switching instruction. According to this configuration, it is possible to preferentially process an action plan determined to be prioritized by an operator.

Here, in a case where the action plan to be presented is switched in accordance with the switching instruction described above, the control unit 33 may decrease the priority of the action plan before the switching and/or may increase the priority of the action plan after the switching. For example, to cause the priority of the action plan corresponding to “burned-out fluorescent light” set at the first priority to be higher than the priority of the action plan corresponding to “intrusion of person on off-limits place” set at the second priority, the control unit 33 may update these priorities. According to this configuration, it is possible to further optimize the priorities of the action plans.

### 3. Operational Processing

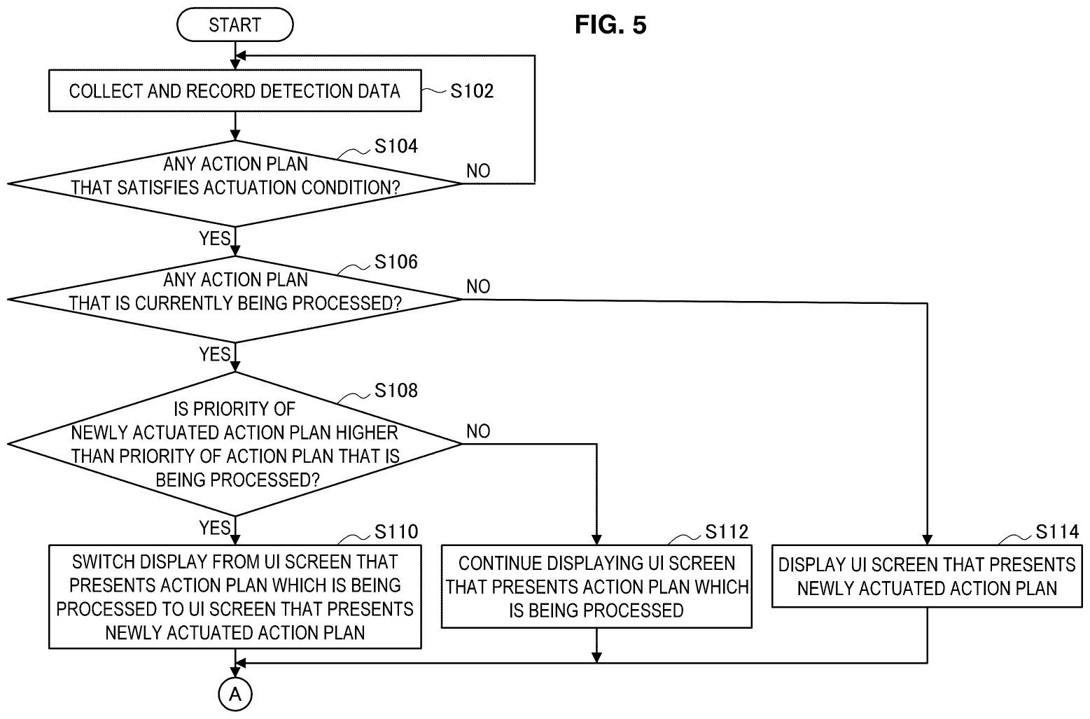

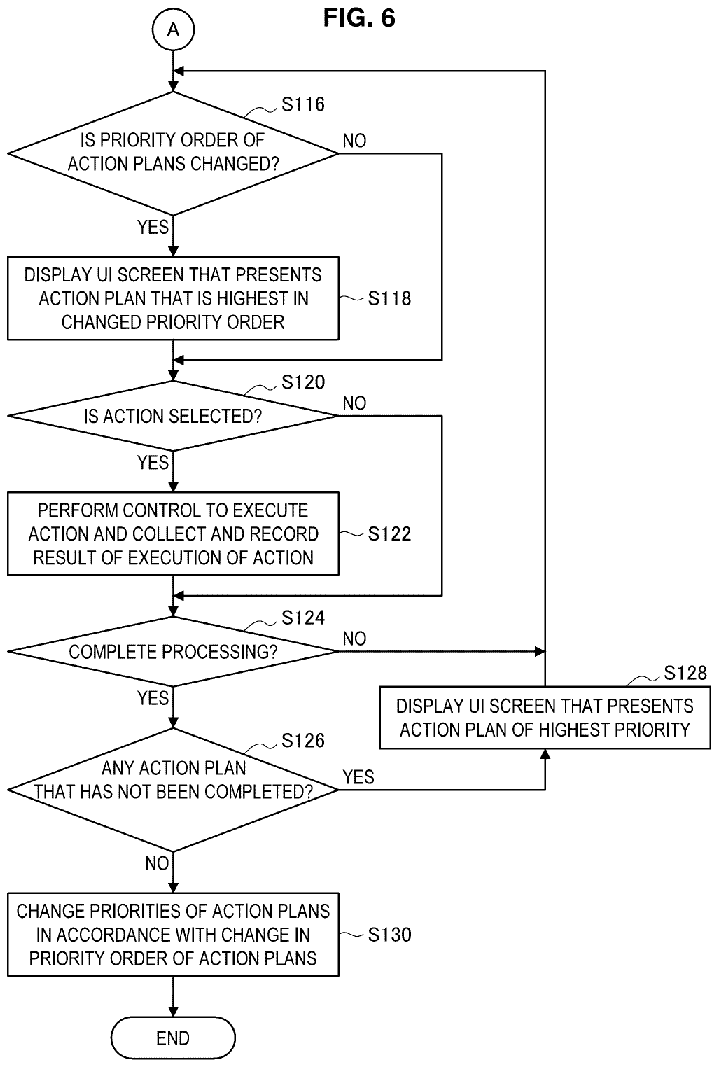

Each of FIGS. 5 and 6 is a flowchart illustrating an example of a flow of processing that is executed by the system 1 according to the present embodiment. The processing according to this flow is executed while the robot 10 is in operation. As illustrated in FIG. 5, the management apparatus 30 first collects detection data and stores and records the collected detection data in the detection table (step S102).

Subsequently, the management apparatus 30 determines whether or not there is any action plan that satisfies an actuation condition (step S104). For example, the management apparatus 30 first reads the off-limits place table, the detection table, and the action plan table. The management apparatus 30 then determines whether or not the action plan table has any action plan whose actuation condition is the acquisition of detection data stored in the detection table.

In a case where it is determined that there is no action plan which satisfies the actuation condition (step S104: NO), the processing returns to step S102 again. At that time, the management apparatus 30 may stand by for a predetermined time.

In a case where it is determined that there is an action plan which satisfies the actuation condition (step S104: YES), the management apparatus 30 determines whether or not there is any action plan that is currently being processed (step S106).

In a case where it is determined that there is an action plan which is currently being processed (step S106: YES), the management apparatus 30 determines whether or not the priority of a newly actuated action plan is higher than the priority of the action plan that is currently being processed (step S108).

In a case where it is determined that the priority of the newly actuated action plan is higher than the priority of the action plan which is being processed (step S108: YES), the management apparatus 30 controls the operator terminal 20 to cause the operator terminal 20 to switch the display from the UI screen that presents the action plan which is being processed to a UI screen that presents the newly actuated action plan (step S110). For example, in a case where the action plan corresponding to “intrusion of person on off-limits place” is actuated while the UI screen that presents the action plan corresponding to “burned-out fluorescent light” is being displayed, the operator terminal 20 displays the UI screen that presents the action plan corresponding to “intrusion of person on off-limits place”. After that, the processing proceeds to step S116.

Meanwhile, in a case where it is determined that the priority of the newly actuated action plan is equal to or lower than the priority of the action plan which is being processed (step S108: NO), the management apparatus 30 controls the operator terminal 20 to cause the operator terminal 20 to continue displaying the UI screen that presents the action plan which is being processed (step S112). For example, in a case where the action plan corresponding to “burned-out fluorescent light” is actuated while the UI screen that presents the action plan corresponding to “intrusion of person on off-limits place” is being displayed, the operator terminal 20 continues displaying the UI screen that presents the action plan corresponding to “intrusion of person on off-limits place”. The display indicating “burned-out fluorescent light” is, however, added below the display indicating “intrusion of person on off-limits place” in the UI element E6. After that, the processing proceeds to step S116.

In a case where it is determined in step S106 that there is no action plan which is currently being processed (step S106: NO), the management apparatus 30 controls the operator terminal 20 to cause the operator terminal 20 to display a UI screen that presents the newly actuated action plan (step S114). For example, in a case where only the action plan corresponding to “burned-out fluorescent light” is actuated, the operator terminal 20 displays a UI screen that presents the action plan corresponding to “burned-out fluorescent light”. After that, the processing proceeds to step S116.

Next, as illustrated in FIG. 6, the management apparatus 30 determines whether or not the priority order of the action plans is changed (step S116). For example, the management apparatus 30 determines whether or not a user operation (i.e., selecting the button of the UI element E7 illustrated in FIG. 4) that changes the priority order of the action plans is performed in a UI screen displayed on the operator terminal 20.

In a case where it is determined that the priority order of the action plans is changed (step S116: YES), the management apparatus 30 controls the operator terminal 20 to cause the operator terminal 20 to display a UI screen that presents the action plan that is the highest in the changed priority order (step S118). For example, in a case where the priority of the action plan corresponding to “burned-out fluorescent light” is changed to the first priority while a UI screen that presents the action plan corresponding to “intrusion of person on off-limits place” is being displayed, the operator terminal 20 switches the display to a UI screen that presents the action plan corresponding to “burned-out fluorescent light”. After that, the processing proceeds to step S120.

Meanwhile, in a case where it is determined that the priority order of the action plans is not changed (step S116: NO), the operator terminal 20 retains the UI screen that is being displayed instead of switching the UI screen. After that, the processing proceeds to step S120.

Subsequently, the management apparatus 30 determines whether or not an action is selected (step S120). For example, the management apparatus 30 determines whether or not a user operation (i.e., selecting a button of the UI element E4 illustrated in FIGS. 3 and 4) that selects an action to be executed next is performed in a UI screen displayed on the operator terminal 20.

In a case where no action is selected (step S120: NO), the processing proceeds to step S124.

In a case where an action is selected (step S120: YES), the management apparatus 30 performs control to execute the action, collects a result of the execution of the action, and records the result as an operation log (step S122). As an example, the management apparatus 30 controls the robot 10 to cause the robot 10 to output sound and then records the time at which the robot 10 outputs sound, the content of the outputted sound, the outputted sound causing a person who intrudes on an off-limits place to leave as a result, and the like as an operation log. As another example, the management apparatus 30 controls the operator terminal 20 to cause the operator terminal 20 to make a voice call between an equipment manager and the operator and then records the time at which the operator terminal 20 made the voice call to the equipment manager, the content of the voice call, the replacement of the fluorescent light as a result of the voice call, and the like as an operation log. Additionally, in a case where the robot 10 executes an action, the management apparatus 30 writes the action plan ID of an action plan that is being processed and the name of the action to be executed in the robot table shown in Table 1. After that, the processing proceeds to step S124.

Next, the management apparatus 30 determines whether or not the processing of the action plan is completed (step S124). For example, in a case where a user operation (i.e., selecting the button of the UI element E5 illustrated in FIGS. 3 and 4) for inputting the processing completion is performed in a UI screen displayed on the operator terminal 20, the management apparatus 30 determines that the processing is completed. If not, the management apparatus 30 determines that the processing is not completed.

In a case where it is determined that the processing of the action plan is not completed (step S124: NO), the processing returns to step S116 again.

In a case where it is determined that the processing of the action plan is completed (step S124: YES), the management apparatus 30 determines whether or not there is any action plan that has not been completed (step S126).

In a case where it is determined that there is an action plan which has not been completed (step S126: YES), the management apparatus 30 controls the operator terminal 20 to cause the operator terminal 20 to display a UI screen that presents the action plan of the highest priority among the action plans that have not been completed (step S128). After that, the processing returns to step S116 again.

In a case where it is determined that there is no action plan which has not been completed (step S126: NO), the management apparatus 30 changes the priorities of the action plans in accordance with the content of the change in the priority order of the action plans (step S130). For example, it is assumed that the action plan corresponding to “burned-out fluorescent light” is set to be higher in priority order than the action plan corresponding to “intrusion of person on off-limits place” in step S116. In this case, the management apparatus 30 changes the priority of the action plan corresponding to “intrusion of person on off-limits place” in the action plan table shown in Table 4, for example, to “8”, which is lower than the priority of the action plan corresponding to “burned-out fluorescent light”.

After that, the processing ends.

### 4. Modification Example

The system 1 may distribute the processing of an action plan to a plurality of operators.

If described in detail, the management apparatus 30 may perform control to cause the operator terminal 20 of an operator having a smaller number of calls to preferentially present the action plan. For example, in a case where an action plan is actuated, the control unit 33 selects the operator having the smallest number of calls in the operator table and controls the operator terminal 20 of the operator to cause the operator terminal 20 to present the action plan.

At that time, the control unit 33 may select the operator having the smallest total number of calls for all the action plans. Alternatively, the control unit 33 may select the operator having the smallest number of calls for the actuated action plan.

An operator who satisfies a predetermined condition may be, however, excluded from calling targets. An example of the predetermined condition may include processing an action plan that is higher in priority than a newly actuated action plan.

According to this configuration, it is possible to level workloads between operators and have all the operators have uniform experience.

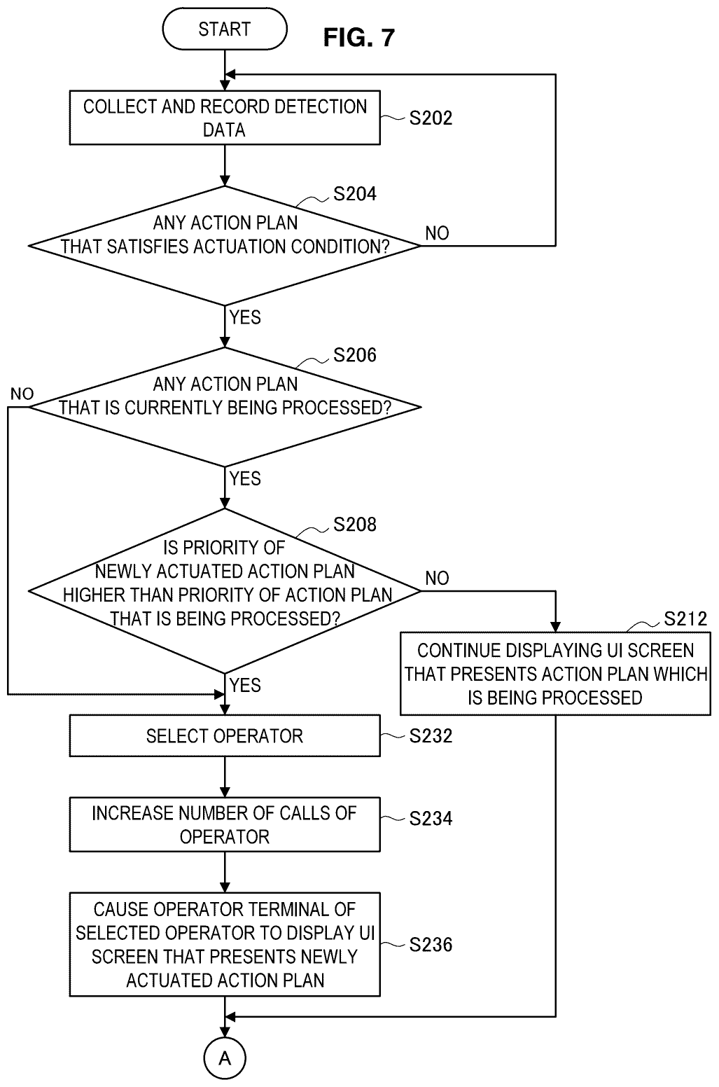

A flow of processing according to the present modification example will be described below with reference to FIG. 7.

FIG. 7 is a flowchart illustrating an example of a flow of processing that is executed by the system 1 according to the present modification example. The processing according to this flow is executed while the robot 10 is in operation.

Steps S202 to S208 illustrated in FIG. 7 are similar to steps S102 to S108 described above with reference to FIG. 5. However, in a case where it is determined in step S206 that there is an action plan which is currently being processed (step S206: YES), the processing proceeds to step S208. Meanwhile, in a case where it is determined that there is no action plan which is currently being processed (step S206: NO), the processing proceeds to step S232.

In a case where it is determined in step S208 that the priority of the newly actuated action plan is lower than the priority of the action plan which is being processed (step S208: NO), the operator terminal 20 is controlled to continue displaying the UI screen that presents the action plan which is being processed (step S212). After that, the processing proceeds to step S116 illustrated in FIG. 6.

In a case where it is determined in step S208 that the priority of the newly actuated action plan is higher than the priority of the action plan which is being processed (step S208: YES), the management apparatus 30 selects an operator who is to process the newly actuated action plan (step S232). For example, the management apparatus 30 selects the operator having the smallest number of calls with reference to the operator table.

Subsequently, the management apparatus 30 increases the number of calls of the selected operator and updates the operator table (step S234).

Next, the management apparatus 30 causes the operator terminal 20 of the selected operator to display a UI screen that presents the newly actuated action plan (step S236). Here, in a case where the selected operator terminal 20 has an action plan that is currently being processed, the management apparatus 30 controls the selected operator terminal 20 to cause the selected operator terminal 20 to switch a UI screen to be displayed to the UI screen that presents the newly actuated action plan. Meanwhile, in a case where the selected operator terminal 20 has no action plan that is currently being processed, the management apparatus 30 controls the selected operator terminal 20 to cause the selected operator terminal 20 to display the UI screen that presents the newly actuated action plan. After that, the processing proceeds to step S116 illustrated in FIG. 6.

### 5. Hardware Configuration Example

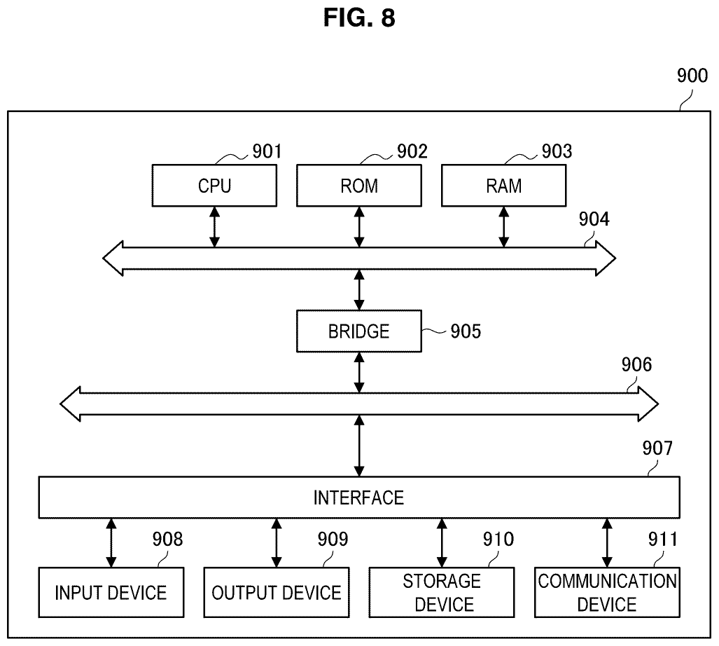

Subsequently, a hardware configuration of an information processing apparatus according to the present embodiment will be described with reference to FIG. 8. FIG. 8 is a block diagram illustrating an example of the hardware configuration of the information processing apparatus according to the present embodiment. Additionally, an information processing apparatus 900 illustrated in FIG. 8 may implement, for example, part of the robot 10, the operator terminal 20, or the management apparatus 30 illustrated in FIG. 1. Information processing by the robot 10, the operator terminal 20, or the management apparatus 30 according to the present embodiment is achieved in cooperation between software and hardware described below.

As illustrated in FIG. 8, the information processing apparatus 900 includes a central processing unit (CPU) 901, a read only memory (ROM) 902, a random access memory (RAM) 903, a host bus 904, a bridge 905, an external bus 906, an interface 907, an input device 908, an output device 909, a storage device 910, and a communication device 911.

The CPU 901 functions as an arithmetic processing device and a control device and controls an overall operation in the information processing apparatus 900 in accordance with various programs. In addition, the CPU 901 may be a microprocessor. The ROM 902 stores a program, an operation parameter, and the like that are used by the CPU 901. The RAM 903 temporarily stores a program that is used in the execution of the CPU 901, a parameter that changes as appropriate in the execution, and the like. They are connected to each other by the host bus 904 including a CPU bus or the like. The CPU 901 may form, for example, the control unit 17 or the control unit 33 illustrated in FIG. 1.

The host bus 904 is connected to the external bus 906 such as a peripheral component interconnect/interface (PCI) bus through the bridge 905. Additionally, the host bus 904, the bridge 905, and the external bus 906 do not necessarily have to be configured as separate components and the functions thereof may be implemented in one bus.

The input device 908 includes an input means for a user to input information such as a mouse, a keyboard, a touch panel, a button, a microphone, a switch, and a lever, an input control circuit that generates an input signal on the basis of an input by the user and outputs the input signal to the CPU 901, and the like. It is possible for a user who operates the information processing apparatus 900 to input various kinds of data to the information processing apparatus 900 or instruct the information processing apparatus 900 to perform a processing operation by operating this input device 908. The input device 908 may form, for example, the operation unit 14 or the operation unit 23 illustrated in FIG. 1.

The output device 909 includes, for example, a display device such as a cathode ray tube (CRT) display device, a liquid crystal display (LCD) device, an organic light emitting diode (OLED) device, or a lamp, and a sound output device such as a speaker. The output device 909 may form, for example, the work unit 13 or the display unit 22 illustrated in FIG. 1.

The storage device 910 is a device for data storage. The storage device 910 may include a storage medium, a recording device that records data on the storage medium, a readout device that reads out data from the storage medium, a deletion device that deletes data recorded on the storage medium, and the like. The storage device 910 includes, for example, a hard disk drive (HDD). This storage device 910 drives a hard disk and stores a program that is executed by the CPU 901 and various kinds of data. The storage device 910 may form, for example, the storage unit 16 or the storage unit 32 illustrated in FIG. 1.

The communication device 911 is, for example, a communication interface including a communication device or the like for a connection to a network. In addition, the communication device 911 may support any of wireless communication or wired communication. The communication device 911 may form, for example, the communication unit 15, the communication unit 31, or the communication unit 21 illustrated in FIG. 1.

The example of the hardware configuration that allows the functions of the information processing apparatus 900 according to the present embodiment to be implemented has been described above. The respective structural elements described above may be implemented by using general-purpose members or may be implemented by hardware that is specialized in the functions of the respective structural elements. It is thus possible to use a different hardware configuration as appropriate depending on the technical level at the time of carrying out the present embodiment.

### 6. Supplementary Information

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

The example has been described above in which, in a case where an action plan of higher priority is newly actuated, the management apparatus 30 compulsorily switches the display of the operator terminal 20 to display a UI screen that presents the newly actuated action plan, but the present invention is not limited to this example. The management apparatus 30 may obtain consent from an operator and then control the operator terminal 20 to cause the operator terminal 20 to switch the display. In a case where an operator does not consent to switch display, the management apparatus may control the operator terminal 20 to cause the operator terminal 20 to continuously display a UI screen that presents an action plan which is being processed. In this case, the management apparatus 30 may update the priorities of the action plans on the assumption that the priority order is changed.

The example has been described above in which the sensor unit 11 of the robot 10 acquires sensor data, but the present invention is not limited to this example. A wearable sensor worn by an equipment manager or a security guard or a sensor installed in an environment may collect sensor data and an action plan may be actuated on the basis of this sensor data.

The robot 10 that autonomously moves on the ground has been demonstrated above as an example of a terminal apparatus that acquires sensor data and executes an action, but the present invention is not limited to this example. As an example, the terminal apparatus may be a drone that autonomously flies. As another example, the terminal apparatus may be an apparatus having no movement function such as a surveillance camera or a digital signage.

Each of the apparatuses described herein may be implemented as an individual apparatus or some or all of the apparatuses may be implemented as different apparatuses. For example, at least some of the functions of the management apparatus 30 may be disposed on the cloud.

It is to be noted that the process by each device described herein may be achieved by software, hardware, or a combination of software and hardware. A program constituting software is stored in advance, for example, in a storage medium (more specifically, a non-transitory computer-readable storage medium) provided inside or outside each device. When executed by a computer that controls each device described herein, for example, each program is loaded into a random-access memory (RAM) and executed by a processing circuit such as central processing unit (CPU). The storage medium is, for example, a magnetic disk, an optical disc, a magneto-optical disk, a flash memory, or the like. In addition, the computer program may be distributed over a network, instead, without using a storage medium. In addition, the computer may be an integrated circuit for a specific application such as an application specific integrated circuit (ASIC), a general-purpose processor that executes a function by reading a software program, a computer on a server used for cloud computing, or the like. In addition, the process by each device described herein may be performed centrally by a single computer or performed by a plurality of computers in a distributed manner. In addition, in each of the above embodiments, the two or more communication means in one device may be achieved physically in one medium.

Further, in the present specification, the processes described using the flowcharts and the sequence diagrams are not necessarily executed in the order illustrated in the drawings. Some processing steps may be executed in parallel. In addition, additional processing steps may be employed and some processing steps may be omitted.

What is claimed is:

1. A management apparatus comprising:
a control unit configured to determine actuation of an action plan on a basis of sensor data acquired by a terminal apparatus and control an operator terminal to cause the operator terminal to present the action plan determined to be actuated, wherein
in a case where actuation of a plurality of the action plans is determined, the control unit controls the operator terminal to cause the operator terminal to present the action plan of highest priority.

2. The management apparatus according to claim 1, wherein, in a case where actuation of the action plan that is higher in priority than the action plan that is being presented by the operator terminal is determined, the control unit controls the operator terminal to cause the operator terminal to switch the action plan to be presented to the action plan that is higher in priority.

3. The management apparatus according to claim 1, wherein, in a case where processing of the action plan is completed, the control unit controls the operator terminal to cause the operator terminal to present the action plan of the highest priority among the other action plans whose processing has not yet been completed.

4. The management apparatus according to claim 1, wherein, in a case where a switching instruction to switch the action plan to be presented is inputted to the operator terminal, the control unit controls the operator terminal to cause the operator terminal to switch the action plan to be presented in accordance with the switching instruction.

5. The management apparatus according to claim 4, wherein, in a case where the action plan to be presented is switched in accordance with the switching instruction, the control unit decreases priority of the action plan before switching and/or increases priority of the action plan after the switching.

6. The management apparatus according to claim 1, wherein the control unit performs control to cause the operator terminal of an operator having a smaller number of calls to preferentially present the action plan.

7. A system comprising:
a terminal apparatus configured to acquire sensor data;
an operator terminal configured to be operated by an operator; and
a management apparatus configured to determine actuation of an action plan on a basis of the sensor data and control the operator terminal to cause the operator terminal to present the action plan determined to be actuated, wherein
in a case where actuation of a plurality of the action plans is determined, the management apparatus controls the operator terminal to cause the operator terminal to present the action plan of highest priority.

8. The system according to claim 7, wherein, in a case where the actuation of a plurality of the action plans is determined, the operator terminal displays a list of a plurality of the action plans in order of priority.

9. The system according to claim 7, wherein the terminal apparatus is an autonomously movable robot.

10. An information processing method that is executed by a computer, the information processing method comprising
determining actuation of an action plan on a basis of sensor data acquired by a terminal apparatus and controlling an operator terminal to cause the operator terminal to present the action plan determined to be actuated, wherein
in a case where actuation of a plurality of the action plans is determined, the controlling the operator terminal includes controlling the operator terminal to cause the operator terminal to present the action plan of highest priority.
